(19) United States
(12) Patent Application Publication
(10) Pub. No.: US 2026/0001787 A1
(43) Pub. Date: Jan. 1, 2026

(54) Water Container for Producing Hydrogen Rich Water from Drinking Water

(71) Applicant: Jesus Perea-OcHoa, Montebello, CA (US)

(72) Inventor: Jesus Perea-OcHoa, Montebello, CA (US)

(21) Appl. No.: 19/184,599

(22) Filed: Apr. 21, 2025

Related U.S. Application Data
(60) Provisional application No. 63/636,799, filed on Apr. 21, 2024.

(51) Int. Cl. C02F 1/461

(52) U.S. Cl. CPC C02F 1/46114; C02F 2201/005; C02F 2201/007; C02F 2307/10

(57) ABSTRACT

A water container for producing hydrogen rich water from drinking water, includes a main container configured for containing a drinking water, an attachable and detachable section container configured to collect and separate from the main container, a cap configured to enclose the main container, an electrolytic component provided in the main container and configured to produce hydrogen rich water in the section container from the drinking water contained in the main container, and a gas pressure valve configured to release as a pressure in either in the section container or the main container excesses a predetermined pressure.

### CROSS REFERENCE OF RELATED APPLICATION

This application is a Nonprovisional application that claims the benefit of priority under 35U.S.C. § 120 to a provisional application, application No. 63/636,799, filed Apr. 21, 2024, which is incorporated herewith by reference in its entity.

### BACKGROUND OF THE PRESENT INVENTION

### Field of Invention

The invention relates to an electrolysis system, and more particularly to a non-insulated or insulated water container for producing hydrogen rich water from drinking water for the purpose of a complete wellness system for pre-workout and during prolong physical demands.

### Description of Related Arts

Currently water containers lack the technology for producing H2 rich water within the same container that is capable of separating regular water with hydrogen rich water within the water container and at the same time providing regular water for producing additional hydrogen rich water. In other words, users of the hydrogen rich containers are limited to only caring an 8 oz supply of water. The container only allows for an 8 oz liquid capacity. Furthermore, if the user wants additional hydrogen rich water the user will have to carry additional separated water containers to refill the hydrogen rich container to produce more hydrogen rich water.

Consumers are forced to purchase individual water containers in addition to the hydrogen container for making hydrogen rich water in various quantities. Thereby, increasing cost, storage requirements and carrying capacity. It is well understood that water is H₂O, for example Hydrogen rich water saturated with Hydrogen, wherein hydrogen is well known as a mediator for reducing inflammation and promoting a healthy biological immune system. The hydrogen sicks ions like OH and ONOO to attach to and thereby prevent DNA damage, within the human body. Hydrogens are also known for reduction of pro-inflammatory markers and inflammatory cytokines, IL-1B, IL-6TNF-<, ICAM-1, and HMGB-1 and pro adoptive factors, caspase-3, caspase-12, caspase-8, and Bax. Hydrogen increases the expression of anti-apoptic factors, Bel-2 and Bcl-xL. These facts make hydrogen water an ideal hydration consumption for recovery and maintenance.

Most healthy humans require about or above eight glasses of water for staying hydrated. However, fewer than eight glasses for some humans with various illnesses is substandard for optimal wellness. Presently, to meet the optimal wellness, we purchase various separate drinking waters without maximizing the full benefits of the drinking water we purchased, in other words our purchased drinking water can be optimized to meet our current medical conditions, physical conditions, and our environment demands. Having a water container that can dispense hydrogen rich water is a natural approach to healthy living. Additionally, it is the most responsible way to reduce environmental waste, by not depending on multiple sources of containers that after the water is utilized become a source of waste. Additionally, the consumer saves money on the cost for staying hydrated. The user has less storage requirements and also less carry-on container requirements, thereby increasing the convenience of staying hydrated.

The technology allows for the drinking water to have multiple applications from the same electrolysis processes that is within the same water container, including the utilization relation to the byproduct of hydrogen (H₂) or oxygen (O₂) gas production during the production of hydrogen rich water. It is possible to combine various scents to offer oxygen for aromatherapeutic benefits from the O₂ byproduct when interchanging from the production of hydrogen rich water. In other words, the user can inhale H₂ from the water container electrolysis system as the water container is turned-on from the selected electrolysis system to enrich the drinking water with freely non-bonded hydrogen.

### SUMMARY OF THE PRESENT INVENTION

The invention is advantageous in that it provides a water container that is over 16 oz is the preferred size for at less two servings sizes of one glass 8 oz of hydrogen rich water and one glass 8 oz refill for hydrogen rich water or one glass 8 oz of regular water separated from the 8 oz hydrogen rich water. This is the most natural and convenient way for optimizing physical performance and recovery. The invention teaches the water container over 16 oz as the means to a healthier alternative and convenient option to the individualized single serving hydrogen beverages containers currently existing in today's market. It is important to mention that the hydrogen rich water produces oxygen gas that can provide a relaxation component to the user prior to strenuous physical activities and alternatively after the strenuous physical activity the oxygen gas can be used for relaxation like aromatherapy.

Another advantage of the invention is to promote drinking water consumption from an insulated water container.

Another advantage of the invention is to promote drinking water consumption from a non-insulated water container.

Another advantage of the invention is to promote drinking water consumption and/or hydrogen rich water from an insulated water container.

Another advantage of the invention is to promote drinking water consumption and/or hydrogen rich water from a non-insulated water container.

Another advantage of the invention is that the oxygen production is also utilized by the water container, wherein liquid and vapor states of drinking water from a non-insulated or insulated water container for total health wellness.

Another advantage of the invention is to provide a source of hydrogen rich drinking water from a non-insulated or insulated water container.

Another advantage of the invention is to provide a source of O₂ rich drinking water from a non-insulated or insulated water container.

Another advantage of the invention is to provide a source for interchangeable hydrogen rich water and or regular drinking water from a non-insulated or insulated water container.

Another advantage of the invention is to provide a source for interchangeable hydrogen rich water and or regular drinking water from a non-insulated or insulated water container, wherein the water container is the same container, thereby reducing the cost of having to purchase other water portable containers.

Another advantage of the invention is to provide a source for interchangeable hydrogen rich water and or regular drinking water from a non-insulated or insulated water container, wherein the water container is the same container, thereby reducing the storage capacity for other beverage water containers.

Another advantage of the invention is to provide a source for interchangeable hydrogen rich water and or regular drinking water from a non-insulated or insulated water container, wherein the water container is the same container, thereby reducing the physical carrying demands for multiple containers require for refills of drinking water.

Another advantage of the invention is to provide a source for interchangeable hydrogen rich water and or regular drinking water from a non-insulated or insulated water container, wherein the water container is the same container, thereby reducing the physical carrying demands for multiple containers require for refills of hydrogen rich water.

Another advantage of the invention is to provide a source for interchangeable hydrogen rich water and or regular drinking water from a non-insulated or insulated water container, wherein the water container is the same container, thereby reducing the physical waste production from the multiple containers require for refills of hydrogen rich water or regular drinking water.

Another advantage of the invention is to provide a water container with the technology for continuous 8 oz servings of hydrogen rich water from the same drinking water within the same water container with minimal effort, reducing multiple single serving beverages containers existing in the market.

Another advantage of the invention is to provide a water container with the technology to produce oxygen gas from the drinking water for aromatherapy benefits, and at the same time enriches the drinking water with hydrogen.

Additional advantages and features of the invention will become apparent from the description which follows, and may be realized by means of the instrumentalities and combinations particular point out in the appended claims.

According to the present invention, the foregoing and other objects and advantages are attained by a water container for producing hydrogen rich water from drinking water, comprising:
a main container configured for containing a drinking water;
an attachable and detachable section container configured to collect and separate from the main container;
a cap configured to enclose the main container;
an electrolytic component provided in the main container and configured to produce hydrogen rich water in the section container from the drinking water contained in the main container; and
a gas pressure valve configured to release as a pressure in either in the section container or the main container excesses a predetermined pressure.

These and other objectives, features, and advantages of the present invention will become apparent from the following detailed description, the accompanying drawings, and the appended claims.

### BRIEF DESCRIPTION OF THE DRAWINGS

FIG. 1 are schematic views illustrating various water containers with various liquid capacities in various oz to illustrate one glass of water at 8 oz, wherein the water container more than 16 oz can be configured to produce hydrogen rich water, according to a preferred embodiment of the invention.

FIG. 2 is a schematic view illustrating a manual twisting separation of the water container according to the preferred embodiment of the invention.

FIG. 3 are schematic views illustrating the water container without a manual water valve within an upper half and therefore a water channel is also not required, nor is a water filter, according to the preferred embodiment of the invention.

FIG. 4 are schematic views illustrating the interoperability of a main cap with a pressure valve for any orifice of the upper separation or the lower separation according to the preferred embodiment of the invention.

FIG. 5 are schematic views illustrating the water container 10 with the attachable/detachable physical 8 oz separation according to the preferred embodiment of the invention.

FIG. 6 is a schematic view illustrating various positions of the previously mentioned components as it relates to the water container without any separation according to the preferred embodiment of the invention.

FIG. 7 is a schematic view illustrating the relation of the drinking water with respect to the water container, the water base reservoir and the vertical cylinder according to the preferred embodiment of the invention.

FIG. 8 is an exploded schematic view illustrating the relation the various macro components have as one and the importance for separating each part from the collective for maintaining each part clean and for replacing components in case of damage or lost according to the preferred embodiment of the invention.

FIG. 9 are schematic views illustrating the various types of caps for the main container orifice and for the vertical cylinder orifice according to the preferred embodiment of the invention.

FIG. 10 are schematic views illustrating all the types and combinations for the hydrogen rich water container according to the preferred embodiment of the invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art.

The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features.

Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

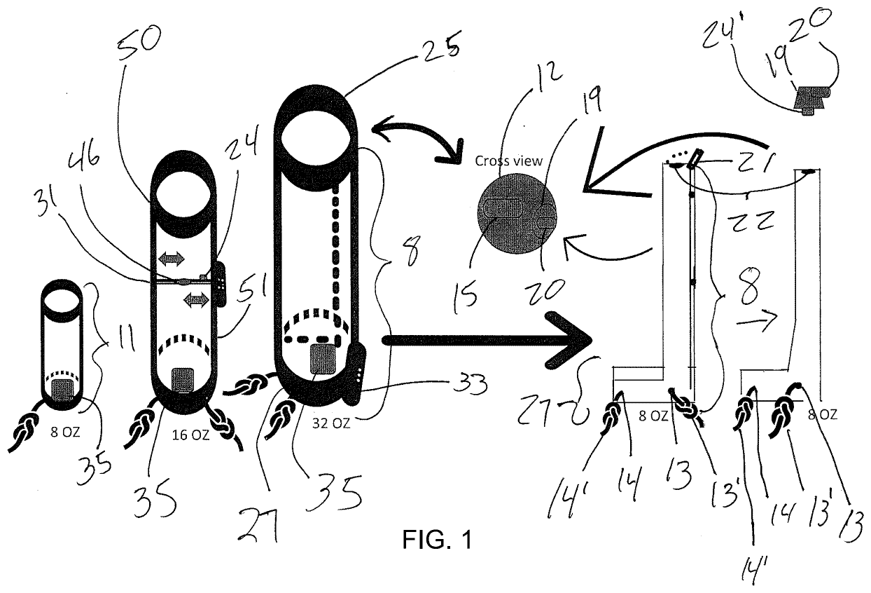

Referring to FIG. 1, various water containers with various liquid capacities in various oz to illustrate one glass of water at 8 oz are illustrated. The invention provides a water container 10 of more than 16 oz, and not the traditional water rich container 11 of only 8 oz. Additionally, the water container 10 of more than 16 oz has the option to also produce hydrogen rich water like the traditional water rich containers 11 of only 8 oz.

Furthermore, the water container more than 16 oz 10 has an attachable and detachable 8 oz section that collects and separates 8 oz from the main container 25. Furthermore, the main container 25 may also be divided in halves, as illustrated by the upper half 50 with an 8 oz capacity and the lower half 51 with also an 8 oz capacity or more. It is important to mention the main container may also be divided one third 8 oz separation within a 24 oz water container or as a quarter 8 oz within a water container more than 32 oz. For example, if the liquid capacity is 16 oz, then the water container 10 may have a manual twisting separation 31 within the middle of the water container, thereby, physically separating the water into two separated containers. Where the lower half 51 is filled with drinking water and the electrolytic component. The upper half 50 is also filled with drinking water that was processed to be rich in hydrogen or is a reservoir for drinking water that may be processed by the lower half 51 on demand. Wherein, the upper half 50 is able to refill the lower half 51 on demand once the lower half liquid has been consumed. Furthermore, the bottom of the upper half 50 has a gas pressure valve 24 to release gas pressure when the electrolytic component 35 in the lower half 51 is activated to produce hydrogen rich water, therefore, the main cap 12 for the main container 25 orifice may also have a pressure valve to assists if the pressure in the lower half 51 becomes too big. It is important to mention the same manual twisting separation 31 may be positioned at one third or at one quarter from the bottom of the water container 10 that is 24 oz or 32 oz, accordantly to the main container 25 liquid capacity, for the purpose of preserving the 8 oz measurement.

The water container 10 of the invention includes electrolytic components 35 which are fixed at the bottom of the water container 10 and may or may not require a manual water valve 33 to be manually operated for opening and closing the water channel 46 that controls the flow of drinking water from main container 25. In other words, the water container 10 may hold more than 8 oz in the main container 25 and the hydrolytic component may or may not produce more than 8 oz of hydrogen rich water, at one time. Furthermore, ideally the main container 25 has an attachable detachable 8 oz physical separation 8 of drinking water from the main container 25 for producing hydrogen rich water and for separating hydrogen rich water previously prepared from the drinking water that may come from the main container 25. Therefore, the user selects the amount of hydrogen rich water he/she wants to drink, and furthermore, the amount of drinking water he/she wants to drink without activating the electrolytic components 35. It is important to mention the attachable/detachable 8 oz physical separation 8, includes the hydrolytic component 35 within a base 27 where the electrical components control the electrolytic components 35. Therefore, the base 27 with the attachable detachable 8 oz physical separation 8 have synergy to balance and maintain the attachable/detachable 8 oz physical separation 8 vertical during the production of hydrogen rich water. Additionally, ON and OFF controls 44 are located at the base 27. It is important to mention, later the invention will show the sliding locking mechanism the main container 25 and the sliding guides 56 on the base 27 have for the purpose of delivering a functional water container 10 with the capacity to produce hydrogen rich water.

At the base 27, the On and Off controls 44 are located, including the electrical cord 13 orifice for charging the internal battery and for operating the hydrolytic components 35 at the same time. The nasal cannula 14 orifice is also positioned at the base 27 for collecting the oxygen as aromatherapy for relaxation during the operation of the hydrolytic component 35. FIG. 1 illustrates a cross view of the main cap 12 for the main container 25 orifice and the drinking mouthpiece 15 for the main container 25. The cross view of the main cap 12 also illustrates the fitting of the attachable/detachable 8 oz physical separation 8, the vertical cylinder cap 19 including an additional vertical cylinder mouthpiece 20 for the attachable detachable 8 oz physical separation 8. Therefore, the main container 25 orifice and the attachable detachable 8 oz physical separation 8 orifice 22, therefore both have independent mouthpieces one for the drinking water 45 and the latter for the separate hydrogen rich water. The cross view also illustrates mouthpiece 15 within the main cap 12 and the second mouthpiece 20 within the attachable detachable cap 19, working individually and collectively to produce one water container cap. In other words, the attachable detachable cap 19 is part of the main cap 12. Both caps service their own orifice, one for the main container 25 orifice and the attachable detachable cap 19 serves the orifice 22 of the attachable/detachable 8 oz physical separation 8. It is important to mention the main cap 12 or the attachable detachable cap 19 may or may not have pressure valves 24 in accordance with the type of water container 10 and the location of the electrolytic components 35. Additionally, the attachable/detachable 8 oz physical separation 8 may have an independent build-in mouthpiece 21 with a pressure valve 24 that attaches and detaches to the main cap 12.

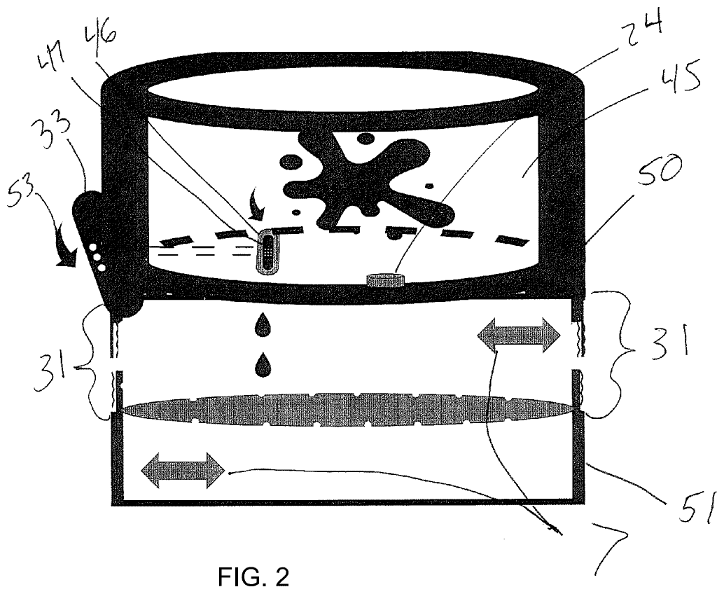

FIG. 2 illustrates the manual twisting separation 31, as it relates to the water container. It is important to mention the water container 10 preferably is a thermal insulated multi-layer container with a larger than 16 oz capacity. With one or more manual twisting separations 31. Additionally, the manual twisting separation 31 is position below the manual water valve 33 and the gas pressure valve 24. Furthermore, the manual twisting separation 31 divides the upper half separation 50 and the lower half separation 51. In other words, the directional arrows 7 show the direction to open and close the liquid chamber 2 that is produce by the upper half 50 and the lower half 51. The directional arrow 53 shows the opening and closing of the manual water valve 33 that is position within the upper half 50 for opening and closing the water channel 46 as the water drains into the water filter 47. It is important to mention the upper half 50 may or may not have drinking water 45, for operating the lower half 51 electrolytic components 35. The lower half 51 will always require drinking water 45 for the electrolytic components 35 to be operational. Therefore, the upper half 50 is a reservoir for the lower half 51. When the manual water valve 33 rotated to the directionally arrow 53 for opening the water channel 46, then the drinking water 45 passes thought the water filter 47, as a filter stream of liquid 42 down into the liquid chamber 2. Now the upper half 50 may or may not have additional drinking water 45. The manual water valve 33 now is rotated to close to prevent leaks from the upper half 50 to the lower half 51 and vice versa. Once the transfer of drinking water 45 has been accomplished the lower half 51 is ready to activate the electrolytic component 35 for producing hydrogen rich water, and at this point the gas pressure valve 24 in the upper half 50 may become functional and may further activate an additional gas pressure valve 24 on the main cap 12 for the upper half 50 orifice.

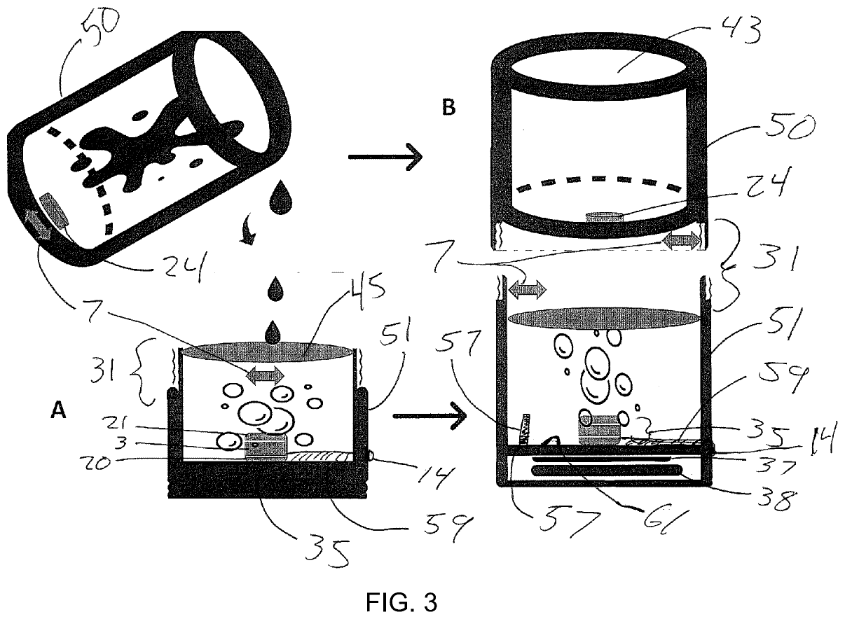

Alternatively, FIG. 3 illustrates the water container 10 without a manual water valve 33 within the upper half 50 and therefore a water channel 46 is also not required, nor is a water filter 47. The alternative process is the water container 10 with two separated containers one is the upper half 50 including a pressure valve 24 the other one is the lower half 51 including the electrolytic component 35. The lower half 51 can be prefilled with drinking water 45 for activating the electrolytic components 35, while the upper half 50 can be filled with different drinking liquids 43, as selected by the user. Additionally, the lower half 51 can be refilled by the upper half drinking water 45, as illustrated in the portion A of the FIG. 3. It is important to mention that direction arrows 7 for twisting the upper half 50 onto the lower half 51 in a close or open manner. Once the lower half 51 has been filled with drinking water 45. The upper half 50 along with the lower half 51 are physically close by rotating the manually twisted separations 31 to the close position. It is important to mention that in the electrolytic component 35 contains then the cathode reduction electrode 21 to produce hydrogen gas for enriching the drinking water 45 in the lower half 51 with hydrogen. Additionally, the electrolytic component 35 contains the anode oxidation electrode 20 for producing oxygen as a byproduct. It is important to mention between the cathode reduction electrode 21 and the anode oxidation electrode 20 there is a barrier of non-conductive material 3 preventing the electrical current from communicating between the cathode reduction electrode 21 and the anode oxidation electrode 20, as both electrodes are in contact with the drinking water 45. Furthermore, the electrolytic component 35 houses the oxygen channel 59 that connects with the nasal cannula 14 orifice for the collection and utilization of oxygen in aromatherapy during the production of oxygen as a byproduct in the process of producing hydrogen rich water within the liquid chamber 2, once the upper half 50 and the lower half 51 are in the close position.

It is important to mention that, in the lower half 51, the electrolytic components 35 and a water sensor 57 are mounted on a water barrier 40, wherein the water barrier 40 surface contacting the water is non-corrosive, non-conductive and non-toxic and is completely airtight separating the drinking water 45 from the dry non-consumable material for housing and delivering electrical power in the operation of the electrolytic component 35. Therefore, underneath the water barrier 40, are more than one component components like, the motherboard controls 37, the AC-DC adapter connector 36, the dry battery holder case build-in generator 38 and are position accordingly to weight distribution and spatial demands for balancing the weight distribution of the water container 10 when completely filled with drinking water 45 or when partially filled with drinking water 45. Additionally, outside of the water container 10 at the end portion of the lower half 51 an interchangeable cap 41 can be repositioned by rotating the cap onto the top orifice of the upper half 50 for closing and opening the upper half 50 orifice. It is important to mentioned that this type of water container does not require a manual water valve 33, as illustrated the upper separation 50 may refilled the lower separation 51 and furthermore the lower separation 51 can be prefilled and then closed by the upper separation 50, additionally the upper separation 50 can be prefilled and close by the main cap 41. Therefore, both the upper and lower containers are field and can be used independently or at the same time and provide more than one serving of hydrogen rich water.

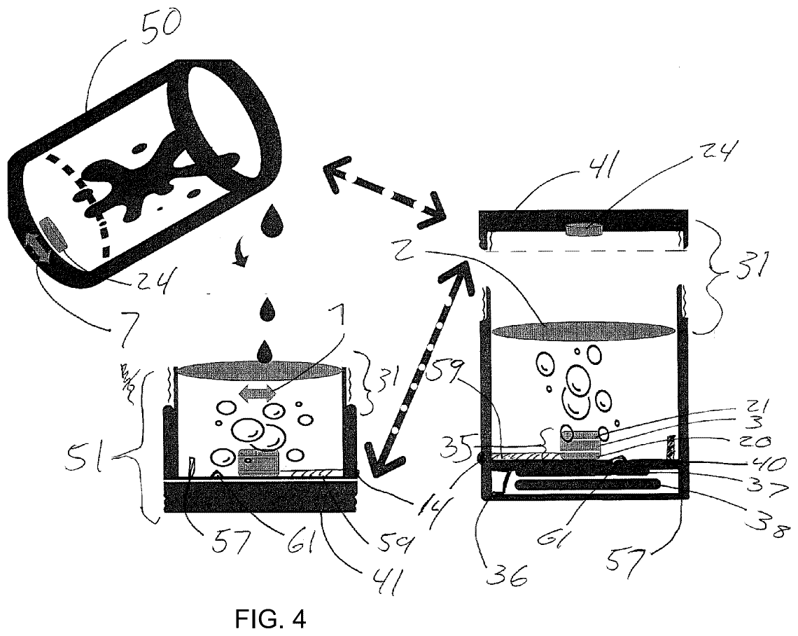

FIG. 4 illustrates the interoperability of the main cap 41 with a pressure valve 24 for any orifice of the upper separation 50 or the lower separation 51. In other words, not only can the manually twisted separation 31 function to open and close liquid chamber 2 between the upper separation 50 and the lower separation 51 orifice the same manually twisting separation 31 can function with the main cap 41 at the bottom of the water container 10 or at the top of the water container 10 or in between on top of the lower separation 51. Alternatively, the upper separation 50 and the lower separation 51 are in accordance with providing one 8 oz glass serving of hydrogen rich water. For example, if the upper separation 50 has two folds the liquid capacity and two folds the size for a total of 16 oz, therefore the lower separation 51 corresponding capacity and size will proportionally be one third the size of the total water container 10 size and capacity for delivering a total of 3 individual servings of 8 oz, for a total of 24 oz of rich hydrogen water, and likewise for 32 oz, etc. Alternatively, if the lower separation 51 is two folds the size and capacity of the upper separation 50, it will be requiring an additional water level sensor, programing and or a manual reduction in the time duration or reduction in intensity for controlling the electrolytic component 35.

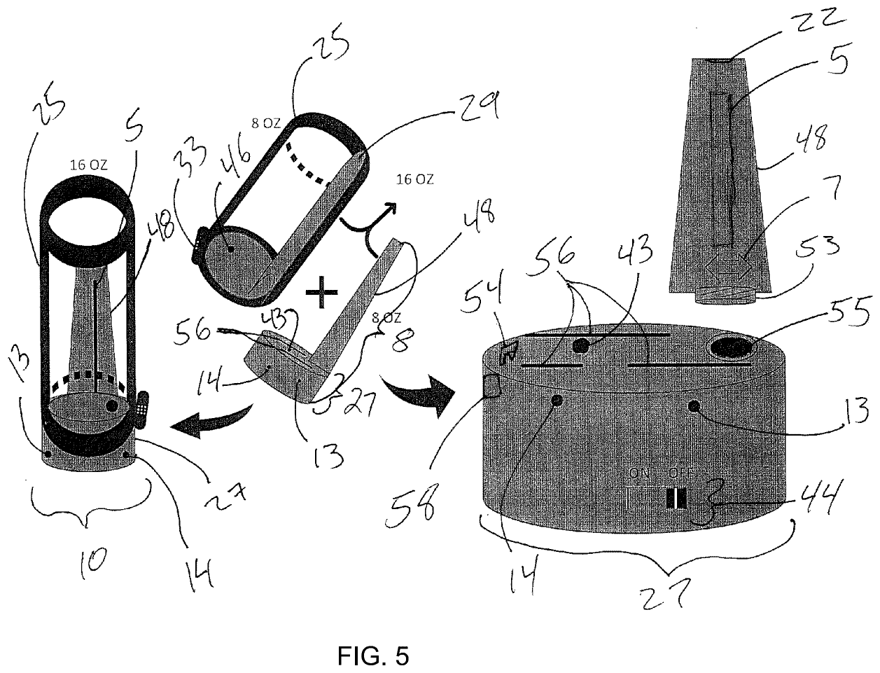

As shown in FIG. 5, the water container 10 with the attachable/detachable physical 8 oz separation 8 is illustrated. It is important to mention alternatively the attachable/detachable physical 8 oz separation 8 may also be larger in size with more capacity than the 8 oz designation, and that including the lower separation 51 previously mention. The invention teaches the convenient of having a main container 25 as a reservoir for housing regular drinking water or producing more hydrogen rich water on demand. The invention teaches the base 27 along with the vertical cylinder 48 are attached and detach by rotating the male screw end 53 into the female screw hole 55, as illustrated by the directional arrows 7. The vertical cylinder may or may not have a transparent vertical window 5 that is transparent and shock resistant, for allowing the user to observe the gas production from the electrolysis operation when the electrolytic component is operational. It is important to mention the operations of an LED lights information 61 that is permanently attached to the water barrier 40 within the base 27, wherein the light production is directed toward the drinking water in the direction of the female screw hole 55, and furthermore the light colors being produce provides the user information of the condition of the water container 10, for example low power supply, electrodes tarnish, and non-operation damage, etc. The user is able to see the various colors from the LED lighting information 61 through the vertical window 5. Additionally, on top of the base 27 the water portal seal 43 is close by the sliding out of the main container 25 and when the main container 25 is slid into the sliding guides 56 the water portal seal 43 is open. It is important to mention the linear guides 56 is operation with a spring-loaded lock 58 that keeps the main container 25 in-place. The release button 59 can be anywhere along the base allowing for a finger press with a push and pull from either hand to release the main container 25 from the base 27 sliding guides 56 and from the spring and lock component 58. Additionally, the ON and OFF control 44 is illustrated anywhere along the base 27, including the electrical cord insertion 13 orifice and the oxygen cannula insertion 14 orifice for the aromatherapy. It is important, to mention there is a wedge/groove fitting 29 is for the attachable/detachable physical 8 oz separation 8. The wedge/groove fitting 29 allows the water container 10 to collectable be one unit and selectable be two separate containers depending on the users' needs. It is possible for the vertical cylinder 48 to also have a locking mechanism with the main container 25. Furthermore, the invention teaches the manual water valve 33 within the bottom surface of the main container 25, wherein the water channel 46 is position directly over the water portal seal 43 for allowing drinking water 45 from the main container 25 to enter inside of the base 27 when the manual water valve is open 33.

As shown in FIG. 5, the various positioning of the previous mention components as it relates to the operation of the water container 10 as one unit and as one or more separations. It is important to mention the attachable/detachable 8 oz physical separation 8 can fully function without the water container 25 attached. Additionally, the water container 25 fully functions as a reservoir that can be used as an independent container. Therefore, it is possible two persons are drinking from the same water container 10 components. For example, the person drinking from the water container 25 may not want hydrogen rich water therefore that user may release the main cap 12 on the top orifice to drink or extend the mouthpiece 15. Furthermore, the other person with the attachable/detachable 8 oz physical separation 8 may also only want drinking water 45 without activation of the electrolytic component 35 and therefore may also release the vertical cylinder cap 19 on the position over the orifice 22 or also extend the mouthpiece 20. that same person may want hydrogen rich water and thereby turns on the electrolytic component 35 where the drinking water 45 is electrolysis through the contact with the cathode reduction electrode 21 and the anode oxidation electrode 20 in the electrolytic component 35 within the base 27 of the attachable/detachable 8 oz physical separation 8.

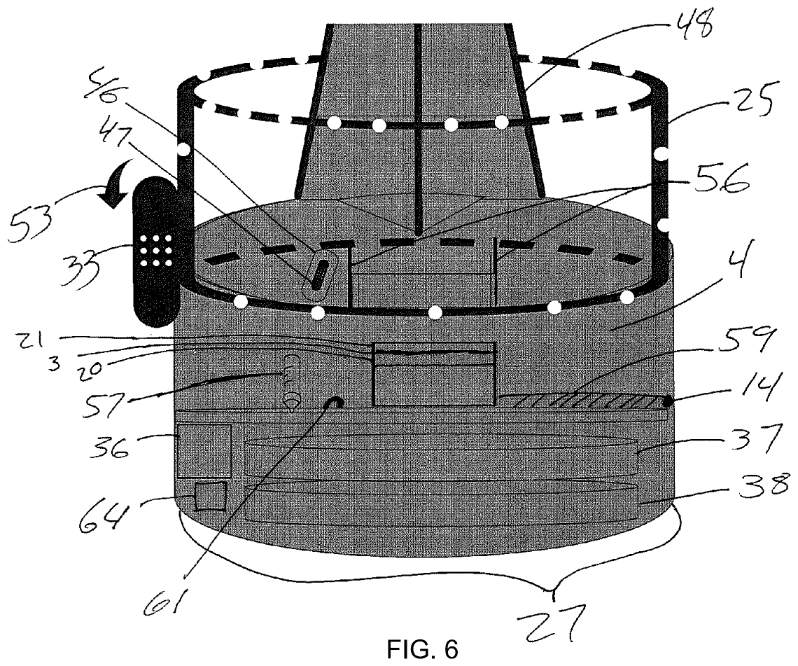

Referring to FIG. 6, the various positioning of the previous mention components as it relates to the water container without any separations are illustrated. In other words, FIG. 6 illustrates the functions of the water container 10 as one unit. Wherein, the entire components work collectively, starting with the main container 25 being attached to the base 27 with the sliding guides 56 and the spring and lock component 58, wherein the vertical cylinder 48 body is within the wedge/grooved fitting 29 of the main container 25, as the vertical cylinder 48 is directly into the base 27 by the male screw end 53 tighten into the female screw hole 55, thereby creating the attachable/detachable 8 oz physical separation 8. As the drinking water 45 is transferred into the base 27, when the water manual valve 33 is open allowing the drinking water into the water channel 46 once the drinking water has passed through the water filter 47. Once inside the base 27 the drinking water pressure will surpass the inside and will continue onto fill the vertical cylinder 48 when the vertical cylinder cap 19 are in the open position. It is important to mention the base 27 and the vertical cylinder 48 together constitute the attachable/detachable 8 oz physical separation 8. In this teaching the 8 oz physical separation 8 is attached and detachable. The rotation opens and closes the manual water valve 33 to allow the drinking water 45 to pass through the water filter 47 into the water channel 46 and through the water portal seal 43 that is open when the spring lock 58 on the base 27 attaches to the main container 25. Thereby allowing the water base reservoir 4 in the base 27/to be filled with drinking water 45. Alternatively, The portal seal 43 may also open and close according to the directional arrow 62 position in relation to the function of the manual water valve 33, in other words, the portal seal 43 may always be closed even when the main container 25 is attached to the base 27 with the spring lock 58, it is the rotation of the manual water valve 33 that mechanically opens the portal seal 43 on the base 27.

It is important to mention, the base and the main container 25 may have a manual lock 54 for securing the transfer of drinking water 45 and preventing leaks from the drinking water 45 for the embodiment of the invention. Furthermore, the drinking bottle 10 also illustrates a water level sensor 57 than will stop the electrolytic component 35 from operating if the water level is inadequate within the water base reservoir 4 in the base 27. Additionally, the electrolytic component 35 houses the cathode reduction electrode 21 and the anode oxidation electrode 20 along with the oxygen channel 59 that connects to the gas cannula 14 orifice. The water Barrie 40 separates the drinking water, provides structure support to the water base reservoir 4, water level sensor 57, the electrolytic components 35, the oxygen channel 59, and the LED lighting 61. It is important to mention the water Barrie 40 separates the dry electrical components like the battery 38, the electrical board 37, the vertical balance 64 and the AC/DC adapter connector 36. It is important to mention all components are connected including the vertical balance sensor 64 that stops all operations within the electrolytic component 35 if the vertical balance sensor 64 determines the water container 10 is not in the vertical position.

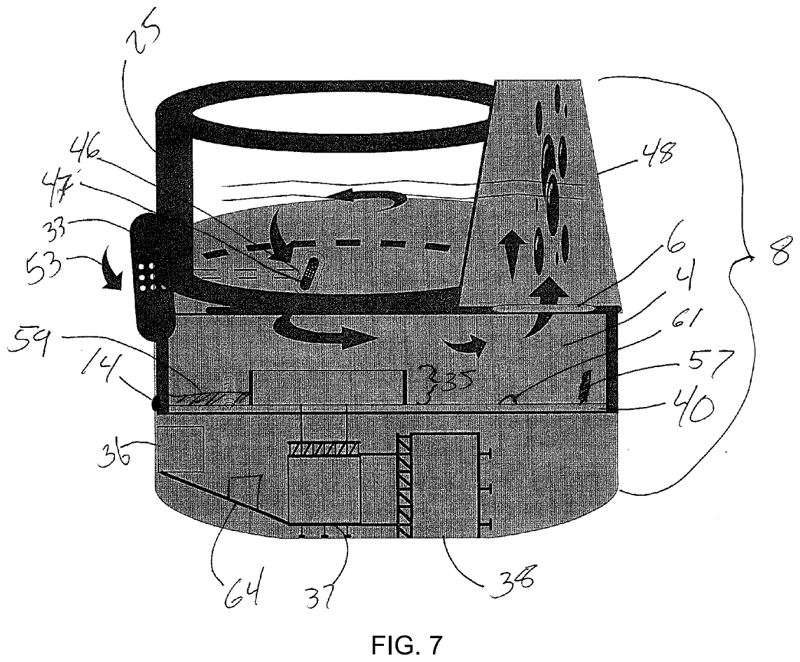

FIG. 7 illustrates the relation the drinking water 45 with respect to the water container 25, the water base reservoir 4 and the vertical cylinder 48. It is important to mention the drinking water 45 quantity within the base 27 in the water base reservoir 4 and in the vertical cylinder 48 are the total volume of water for the attachable/detached 8 oz physical separation 8, as an example. The invention teaches a water container 10 with the capacity to individually house more than 8 Oz for one or more servings of hydrogen rich water, at least. Additionally, the invention teaches the main container 25 for carrying additional drinking water 45 for completely refilling at least once the attachable/detachable 8 oz physical separation 8. Furthermore, the invention teaches the main container 25 may accommodate for more than 8 oz for more than one serving and alternatively the main container 25 may contain more than 8 oz of drinking water 45 irrespective of the capacity of the attachable/detachable 8 oz physical separation 8, including the upper separation 50 and the lower separation 51, mentioned earlier in FIG. 1-4.

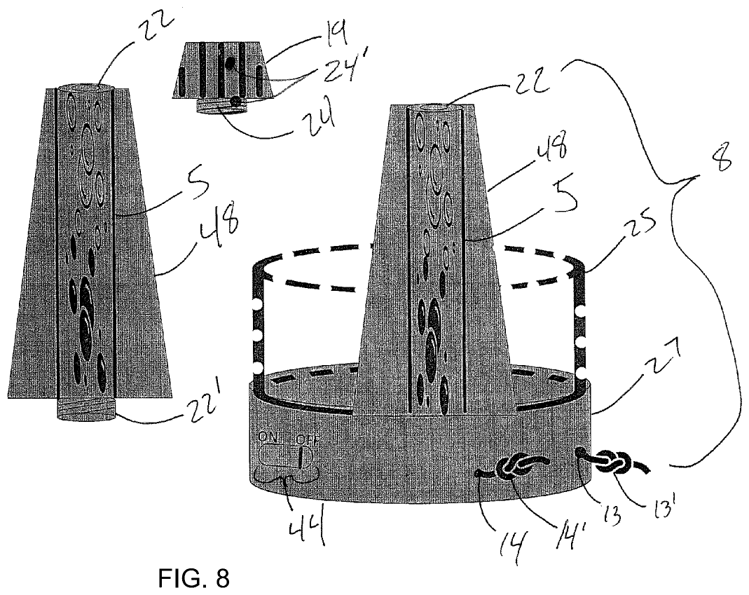

FIG. 8 illustrates the relation the various macro components have as one and the importance for separating each part from the collective for maintaining each part clean and for replacing components in case of damage or lost. The electrolysis window 5 can be a narrow strip of glass or acrylic window or the entire vertical cylinder 48 for the user to notice the activation of the electrolytic component 35 operating and for notifications from the water container to the user via color code lighting from the LED-lighting 61 system, as mentioned earlier. Within the vertical cylinder 48 the orifice run all the way across the body of the vertical cylinder from the top orifice 22 to the bottom orifice 22′. Additionally, the based 27 is shown to have the On and OFF control 44 the two attached male corks 65 for closing the females orifice of the oxygen cannula insertion 14 and of the electrical cord insertion 13 when not in use. Respectively, the electrical cord 13′ and the nasal cannula cord 14′ are illustrated. Additionally, the gas escape orifice 66 from the pressure valve 24 in the vertical cylinder cap 19 is illustrated anywhere in the cap 19. Preferably, the vertical cylinder 48 cap is screw into a lock position and un-screw to open. Furthermore, all of the rotational, twisting or screwing components within the water container 10 have non-toxic rubber or plastic washers or any combination are build-in or attachable and replaceable, where all components material that the user has the potential of contacting with mouth or saliva are FDA approved for coming into contact with human and any type of foods.

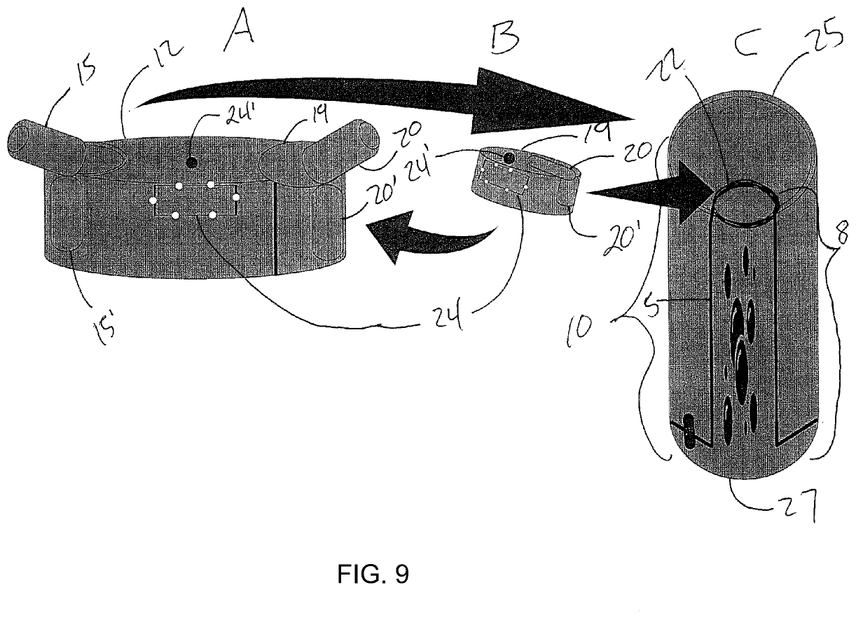

FIG. 9 illustrates various types of caps for the main container 25 orifice and for the vertical cylinder 48 orifice 22. It is important to mention one water container 10 may have two separate caps that when put together are part of one larger cap. As illustrated in FIG. 1 the main cap 12 together with the vertical cylinder cap 19. Now the main cap 12 is illustrated laterally with the vertical cylinder cap 19. Additionally, the main cap 12 has its own mouthpiece 15 and the mouthpiece has its own collapsable groove 15′ for closing the mouthpiece availability to dispense drinking water from the main container 25. For example, Figure B illustrates the mouthpiece 20 for the vertical cylinder cap 19 close within the collapsable groove 20′. It is important to mention the same collapsibility can be provide to either cap at the same time and vice versa either cap with its mouthpiece can be extended or close on demand together or separate for dispensing liquids or for closing and stopping leaks, and for portability. It is important to mention that any cap, including the main cap 12 or the vertical cylinder cap 19 may have a gas relieve orifice 67 for the build-in pressure valve 24 within any cap.

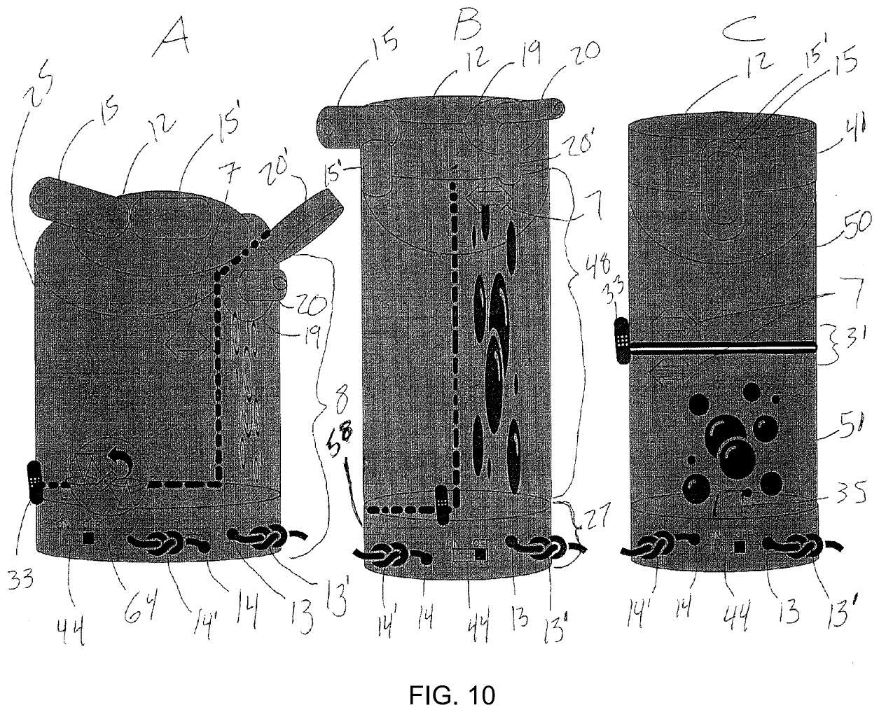

FIG. 10 illustrates all the types and combinations for the hydrogen rich water container 10. It is important to mention the manual water valve 33 is not required in all water containers 10. An attachable 8 oz physical separation 8 with the main container 25 to produce a complete water container 10 is illustrated in FIG. 10(A). It is important to teach the vertical cylinder is attached to the vertical cylinder cap 19 and the mouthpiece 20 has a mouthpiece cover 20′. They are all part of the attachable/detachable 8 oz physical separation 8. In FIG. 10(B), there is a separation within the main container 25 without the attachable/detachable 8 oz physical separation 8. In other words, the water container 10 has separations that are fixed without any detachment or attachment. Furthermore, what is shown in FIG. 10(B) is an example that the main cap 12 contains two mouthpiece one for the hydrogen rich water 20 the other mouthpiece 15 for the drinking water 45, or vice versa. It is important to mention the in this example the cap can be one piece. FIG. 10(C) illustrates an example of a water container 10 with the upper separation 50 and the lower separation 51, including the electrolytic components 35. It is important to mention if the water container 10 is equipped with the twisting separation 31 the manual water valve 33 is not required in the same water container 10. If the water container 10 does not have a manual water valve 33 then the twisting separation 31 is required, and vice versa. Alternatively, the water container 10 may have no separations and the performance of the electrolytic components are engineered to increase hydrogen production for the amount of water the sensors identify. Additionally, the invention teaches the main cap 12 with a collapsible single mouthpiece 15 in the mouthpiece groove 15′. There is a mechanical fasting lock 64 between the base 27 and the main container 25 that secures the positioning and operations of the water container to prevent leakage and cross contamination between the base and the main container 25. The base 27 is illustrated to have the oxygen cannula orifice 14 and the oxygen cannula cord 14, including the electrical cord orifice 13 and the electrical cord 13′. Additionally, the base 27 has the release button 58 for the spring-loaded lock 54 on the linear guides 56, mentioned earlier.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. (canceled)

2. A water container for containing a drinking water, comprising:
a main container configured for containing the drinking water;
an attachable and detachable section container configured to collect and separate from the main container;
a cap configured to enclose the main container;
at least one electrolytic component provided in the main container and configured to produce a hydrogen rich water in the section container from the drinking water contained in the main container; and
a gas pressure valve configured to release gas pressure as a pressure excesses a predetermined pressure in either the section container or the main container.

3. The water container, as recited in claim 2, wherein the main container comprises a separation therein, which is configured to divide and separate the main container into an upper half and a lower half, such that the upper half of the main container forms a reservoir of the drinking water for the lower half and is configured to refill the lower half on demand once the drinking water in the lower half has been consumed, wherein the electrolytic component is provided at a bottom of the water container and arranged to produce the hydrogen rich water in the lower half of the main container, wherein the gas pressure valve is provided at a bottom of the upper half of the main container.

4. The water container, as recited in claim 3, wherein the separation comprises a manual water valve and a manual twisting separation positioned below the manual water valve and the gas pressure valve to control opening and closing of a water channel between the upper half and the lower half by rotating the manual twisting separation, such that when the manual water valve is operated to open the water channel, the drinking water in the upper half passes into the lower half, and when the manual water valve is operated to close the water channel, the upper half and the lower half are separated to prevent leaking therebetween.

5. The water container, as recited in claim 2, wherein the electrolytic component is able to be activated only when the lower half is filled with the drinking from the upper half to produce the hydrogen rich water while the gas pressure valve is functioned to release gas pressure in the lower half when the pressure in the lower half excesses the predetermined pressure.

6. The water container, as recited in claim 3, wherein the electrolytic component is able to be activated only when the lower half is filled with the drinking from the upper half to produce the hydrogen rich water.

7. The water container, as recited in claim 6, further comprising a second gas pressure valve provided in the cap which encloses the upper half of the water container to release gas pressure in the upper half, and the gas pressure valve is provided in the separation to release gas pressure in the lower half, when the electrolytic component is activated to produce the hydrogen rich water.

8. The water container, as recited in claim 4, wherein the electrolytic component is able to be activated only when the lower half is filled with the drinking from the upper half to produce the hydrogen rich water.

9. The water container, as recited in claim 8, further comprising a second gas pressure valve provided in the cap which encloses the upper half of the water container to release gas pressure in the upper half, and the gas pressure valve is provided in the separation to release gas pressure in the lower half, when the electrolytic component is activated to produce the hydrogen rich water.

10. The water container, as recited in claim 2, wherein the electrolytic component comprises a cathode reduction electrode for producing a hydrogen gas for enriching the drinking water in the lower half with hydrogen, and an anode oxidation electrode for producing an oxygen gas as a byproduct.

11. The water container, as recited in claim 10, wherein between the cathode reduction electrode and the anode oxidation electrode, a barrier of non-conductive material is provided for preventing an electrical current from communicating between the cathode reduction electrode and the anode oxidation electrode which are in contact with the drinking water.

12. The water container, as recited in claim 11, wherein the electrolytic component houses an oxygen channel that connects with a nasal cannula orifice for collection and utilization of the oxygen gas in aromatherapy, which is the byproduct in the process of producing the hydrogen rich water, once the upper half and the lower half are in close positions.

13. The water container, as recited in claim 3, wherein the electrolytic component comprises a cathode reduction electrode for producing a hydrogen gas for enriching the drinking water in the lower half with hydrogen, and an anode oxidation electrode for producing an oxygen gas as a byproduct.

14. The water container, as recited in claim 13, wherein between the cathode reduction electrode and the anode oxidation electrode, a barrier of non-conductive material is provided for preventing an electrical current from communicating between the cathode reduction electrode and the anode oxidation electrode which are in contact with the drinking water.

15. The water container, as recited in claim 14, wherein the electrolytic component houses an oxygen channel that connects with a nasal cannula orifice for collection and utilization of the oxygen gas in aromatherapy, which is the byproduct in the process of producing the hydrogen rich water, once the upper half and the lower half are in close positions.

16. The water container, as recited in claim 4, wherein the electrolytic component comprises a cathode reduction electrode for producing a hydrogen gas for enriching the drinking water in the lower half with hydrogen, and an anode oxidation electrode for producing an oxygen gas as a byproduct.

17. The water container, as recited in claim 16, wherein between the cathode reduction electrode and the anode oxidation electrode, a barrier of non-conductive material is provided for preventing an electrical current from communicating between the cathode reduction electrode and the anode oxidation electrode which are in contact with the drinking water.

18. The water container, as recited in claim 17, wherein the electrolytic component houses an oxygen channel that connects with a nasal cannula orifice for collection and utilization of the oxygen gas in aromatherapy, which is the byproduct in the process of producing the hydrogen rich water, once the upper half and the lower half are in close positions.

19. The water container, as recited in claim 9, wherein the electrolytic component comprises a cathode reduction electrode for producing a hydrogen gas for enriching the drinking water in the lower half with hydrogen, and an anode oxidation electrode for producing an oxygen gas as a byproduct.

20. The water container, as recited in claim 19, wherein between the cathode reduction electrode and the anode oxidation electrode, a barrier of non-conductive material is provided for preventing an electrical current from communicating between the cathode reduction electrode and the anode oxidation electrode which are in contact with the drinking water.

21. The water container, as recited in claim 20, wherein the electrolytic component houses an oxygen channel that connects with a nasal cannula orifice for collection and utilization of the oxygen gas in aromatherapy, which is the byproduct in the process of producing the hydrogen rich water, once the upper half and the lower half are in close positions.
